(19) United States
(12) Patent Application Publication
(10) Pub. No.: US 2016/0368750 A1
(43) Pub. Date: Dec. 22, 2016

(54) Can Opener Mechanism

(71) Applicants: Alexander Joshef Kalogroulis, Surrey (GB); Pat Y. Mah, Kowloon (HK)

(72) Inventors: Alexander Joshef Kalogroulis, Surrey (GB); Pat Y. Mah, Kowloon (HK)

(21) Appl. No.: 14/900,294

(22) PCT Filed: Jun. 20, 2014
(86) PCT No.: PCT/GB2014/000243

§ 371 Date: Dec. 21, 2015

(30) Foreign Application Priority Data
Jun. 21, 2013 (GB) 1311135.6

(51) Int. Cl. B67B 7/70; B67B 7/00; B67B 7/44; B67B 7/46

(52) U.S. Cl. CPC B67B 7/32; B67B 7/34; B67B 7/385; B67B 7/44; B67B 2007/303

(57) ABSTRACT

A can opener mechanism (30) which reduces the noise and vibration associated with the use of typical ratchets but remains reliable if contaminated with excess grease, water or small food particles. The mechanism (30) can be used in manual form with a manual rotary input in the form of a butterfly handle or a rotary lever, or can be used in an automatic form in which an electric motor drives the mechanism via a gear train. The can opener mechanism (30) is also suited to being removably mounted into an electrically powered can opener (70) such that the mechanism (30) can be removed and washed independently of the remaining can opener (70) that houses the electrical components.

This invention relates to a quiet, washable and reliable reversal mechanism for use in a can opener that may be used with a manual or an automated drive mechanism.

U.S. Pat. No. 4,365,417 issued to Rosendahl on Dec. 28, 1982 and entitled “TIN OPENER” describes a can opener that uses a drive gear intermittently engaged with a cutter gear that are rotationally mounted on parallel axes to a body. A drive wheel and a drive input handle are mounted coaxially with the drive gear and rotate with it. A cutter is eccentrically mounted to the cutter gear so that when the cutter gear rotates one way or the other, the cutter is moved towards or away from the drive wheel. As the cutter approaches the drive wheel, it will pierce any can lid that is mounted between the two and continue to cut the can lid as long as the cutter remains close to the drive wheel and the drive wheel and drive gear continue turning. In order to allow the required intermittent drive that allows the drive gear to keep turning when the cutter gear is stationary, the cutter gear features a section of missing teeth, positioned so that as the cutter gear rotates, the missing teeth portion aligns with the drive gear and drive engagement is lost. The drive gear and drive wheel can therefore continue to be turned until the lid has been severed.

After cutting the can lid, in order to move the cutter away from the can again, the drive gear needs to reengage with the cutter gear so that it rotates once more and carries the eccentrically mounted cutter away from the drive wheel. This is achieved by a projection, eccentrically positioned on the cutter gear, and a resilient element mounted to the body. Whenever the missing teeth portion of the cutter gear is nearly perfectly aligned with the drive gear, the projection pushes against the resilient element resulting in a torque that is always urging the missing teeth section out of perfect alignment with the drive gear. The effect of this torque is to cause drag and friction between every tooth of the drive gear against the final tooth or tooth portion of the cutter gear before the missing tooth section. This drag and friction will create a regular ‘click’ as each tooth loses contact and a corresponding vibration will be felt in the drive handle and body.

U.S. Pat. No. 2,592,936 issued to McLean on Apr. 15, 1952 and entitled “CAN OPENER” describes a can opener with a similar arrangement of eccentrically mounted cutter, drive wheel, drive gear and drive handle. Instead of a single cutter gear there are two parts that perform a similar function, one circular plate to which is mounted the cutter, and one quadrant plate with gear teeth that engage with the drive gear. As the quadrant plate is driven by the drive gear, a connecting shaft drives the cutter plate at the same speed. When the quadrant plate has been driven to a position in which there are no more teeth, the circular plate stops moving any further. At this point the cutter will be in the cutting position and any can lid will be cut so long as the drive wheel continues to rotate. Because the quadrant plate has been provided with some backlash with respect to the cutter plate, the final quadrant plate tooth will be driven out of engagement by each drive gear tooth and then drop back into engagement. This motion will result in a ‘click’ for each tooth and a corresponding vibration in the body. When the user wishes to disengage the cutter, reversing the direction of turn of the drive handle will allow the drive gear to drive the quadrant plate and the cutter plate in the opposite direction and move the cutter away from the drive wheel.

U.S. patent application Ser. No. 12/807,137 applied by Mah et al on Mar. 1, 2012 and entitled “ROTARY CAN OPENER” describes a near silent can opener mechanism that includes a drive gear with a concentrically mounted and driven drive wheel, a cutter movement gear with an eccentrically mounted cutter, an interference bump on the cutter movement gear and an idle gear.

The cutter movement gear is driven by the drive gear and there are two cut outs in the teeth of the cutter movement gear arranged so that the drive gear will no longer be able to drive the cutter movement gear at each position. The first position is with the cutter moved away from the drive wheel and in this position a can may be inserted or removed from between the cutter and the drive wheel, the second position is with the cutter overlapping the drive wheel such that any can trapped between them would be pierced by the cutter. The cutter will therefore be driven between the first and second position by the drive gear but drive will be lost once either position is reached. The idle gear is loosely mounted around the cutter movement gear in a position such that it is continuously engaged and driven by the drive gear. Because of the loose mounting arrangement it is free to move between to extreme positions, the movement direction being driven by the direction of rotation of the drive gear. The interference bump on the cutter movement wheel is positioned such that the idle gear will either engage with it or not, depending on which direction it has moved in in response to the direction of rotation of the drive gear. If the idle gear engages with the interference bump it starts to drive the cutter movement wheel which causes the cut outs to rotate and allow the drive gear to start to drive the cutter movement wheel directly again. The overall effect is to allow the user to turn the cutter gear clockwise so that a can placed between the cutter and the drive wheel is pierced and cut, the cutting taking place for as long as the drive gear is turned in a clockwise direction. As soon as the user starts to turn the drive gear anticlockwise, the cutter movement gear moves the cutter away from the drive wheel and the can and lid can be removed.

U.S. Pat. No. 7,596,874 issued to Mah et al on Oct. 6, 2009 and entitled “MECHANISM FOR CAN OPENER” describes a can opener with a number of angled, moulded, springs in the cut out section of the cutter wheel gear. These moulded springs act as ratchet teeth and engage with a drive gear so that depending on the direction of rotation of the drive gear, the ratchet teeth will either bend out of the way with little effect, or grip and allow the drive gear to drive the cutter wheel thereby re-engaging the main cutter wheel gear teeth with the drive gear teeth.

The mechanisms to cause gear re-engagement from a position in which a drive gear opposes a cut out portion of another gear are many. However, apart from the Ser. No. 12/807,137 Mat et al application, they use a ratchet arrangement that creates constant noise or vibration as the ratchet teeth slip past each other and this noise and vibration can cause annoyance to the user. This is because they require the gear teeth of the drive gear to repeatedly strike either a ratchet element or the first tooth on the movable cutter gear. The constant striking of the teeth also leads to wear on the teeth. The idle gear of the Ser. No. 12/807,137 Mat et at application is different in that there is no associated teeth impact but the loose mounting arrangement of the idle gear can result in unreliable operation if the idle gear becomes contaminated with excess grease, small food particles or water, the latter two of which are a likely outcome of washing the cutting mechanism.

In solution to this problem, Applicant has devised a can opener mechanism which reduces the noise and vibration associated with the use of typical ratchets but remains reliable if contaminated with excess grease, water or small food particles. The can opener mechanism is also suited to being removably mounted into an electrically powered can opener such that the mechanism can be removed and washed independently of the remaining can opener.

According to one embodiment of the invention there is provided a mechanism for use in an opener for a can, said can comprising a cylindrical or rectangular wall that is closed at either end with a lid sealed to the can by means of an upstanding rim that clamps onto each end of the can wall, said mechanism comprising

A body;

rotationally mounted to said body about a first axis, a drive wheel with serrated drive teeth for engaging the rim of the can and with a full set of concentric drive gear teeth and at least one, separate interference gear tooth;

rotationally mounted to said body about a parallel second axis a cutter wheel with a section of radial gear teeth set between a first toothless zone and a second toothless zone such that the radial gear teeth are drivably rotatable by said drive wheel's drive gear teeth;

eccentrically mounted to said cutter wheel, a cutter movable on rotation of the cutter wheel to a cutting position in which the cutter overlaps the serrated drive teeth such that a can wall placed between the serrated drive teeth and the cutter would be pierced by the cutter whilst the can rim would be gripped between the serrated drive teeth and a cylindrical cutter spacer mounted adjacent to the cutter and concentric with it such that the can wall would be continuously cut as the can rim was driven by the serrated drive teeth;

pivotably mounted to the cutter wheel at least one sprung ratchet member that is able to either engage with said at least one interference gear tooth so that the drive wheel can drivably rotate the cutter wheel at times when said section of radial gear teeth is not engaged with said drive gear teeth, said at least one sprung ratchet member being able to alternatively spring out of engagement with said at least one interference gear tooth if the drive wheel is being turned in the opposite direction with there being no resulting rotary drive.

It will be seen that in order to successfully cut the lid from a can, a number of steps must be taken.

First the mechanism must be placed onto the can and this is achieved by initially rotating the cutter wheel so that the cutter is away from the drive wheel and there is a gap between the serrated drive teeth and the cylindrical spacer, the first or parked position. At this time the first toothless zone is presented to the drive wheel drive gear teeth.

Next, the drive wheel is rotated clockwise, either by hand, motor/gearbox or other means. The drive gear teeth will not be able to engage the cutter wheel radial gear teeth but instead the interference gear tooth will connect with the sprung ratchet member and drive the cutter wheel until the drive gear teeth engage with the radial gear teeth and continue to rotatably drive the cutter wheel. As the cutter wheel rotates, the eccentrically mounted cutter and cylindrical spacer move closer to the can wall and the cutter pierces the can wall. When the cutter wheel has rotated to its cutting position, the second toothless zone on the cutter wheel is adjacent to the drive gear, drive is lost, and the cutter wheel stops rotating. The interference gear tooth now interacts with a second sprung ratchet member but in this case the relative direction of rotation causes the sprung ratchet member to spring out of the way and there is no rotary drive as a result. This means that the drive wheel can continue to be rotated in the same direction and there will be no movement of the cutter wheel. In this cutting position the cylindrical spacer is close enough to the serrated drive teeth so that the can rim is pinched between the two and the can is rotatably driven by the serrated drive teeth. As the can rotates, the cutter cuts through the can wall.

When the can wall has been completely cut through, the lid will come away from the can but still be held by the rim which is trapped between the cylindrical spacer and the serrated drive teeth. In order to release it and return the cutter wheel to the first parked position the drive wheel needs to be turned in the opposite, anticlockwise direction. As soon as the interference gear tooth engages the second sprung ratchet, this time in a direction that will engage rather than spring out of the way, the cutter wheel is rotatably driven by the interference gear tooth until the radial gear teeth reengage with the drive gear teeth and the cutter wheel turns until the drive gear teeth are once more aligned with the first toothless zone. At this point the cutter wheel is in the first parked position and stops rotating. The interference gear tooth will now be interacting again with the first sprung ratchet member but in such a direction that the first sprung ratchet member springs out of the way and no rotary drive is imparted. At this stage the drive wheel rotation can be stopped and the lid can be removed. The mechanism is back in its first parked position ready to cut the next can.

The addition of a cam to the cutter wheel will allow a cam follower to be able to detect at which stage of rotation the cutter wheel has reached and enable the mechanism to be selectively driven by an electrically driven motor.

The result is a can opener that is very simple to use. Simply place the can opener onto the can, turn the drive wheel clockwise until the can lid is severed, then turn anticlockwise until the can lid is released.

The advantage of this mechanism is that the interference gear tooth only strikes a lightly sprung ratchet member once for every revolution, unlike the prior art models that have every drive wheel gear tooth striking a cutter wheel tooth. In addition the sprung ratchet member is very reliable as the spring force can be selected to overcome any contamination of the mechanism by excess grease, small food particles or water. The resulting mechanism will be relatively quiet, quick and easy to use and able to be washed and continue to work reliably.

Embodiments of the present invention will now be described with reference to the accompanying drawings in which:

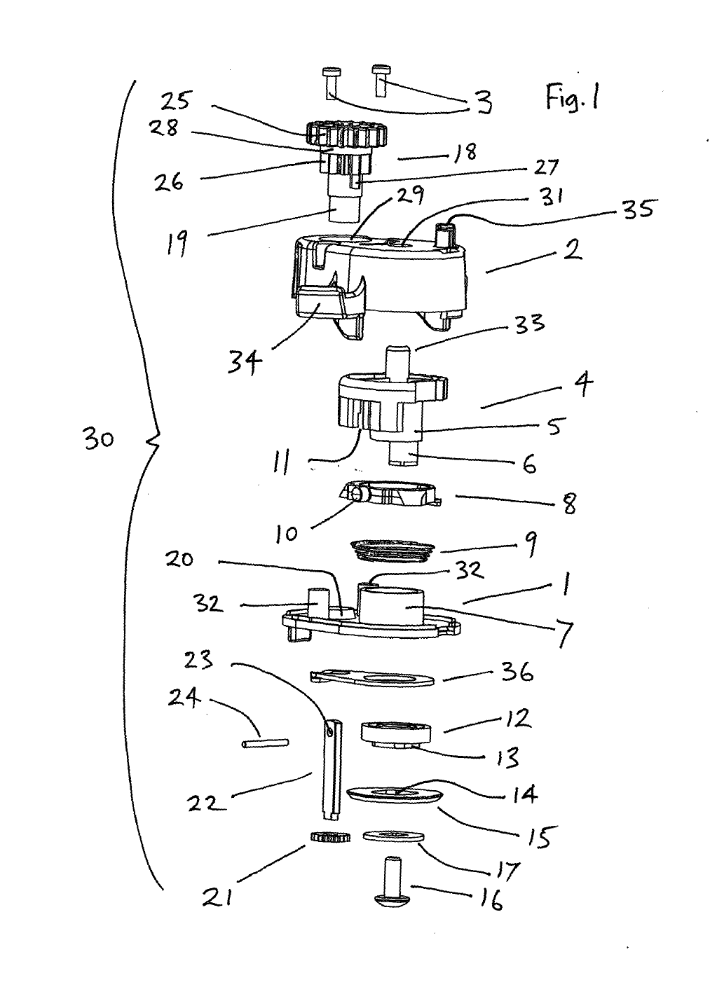

FIG. 1 is an exploded perspective view of one embodiment of mechanism 30 shown for familiarity and orientation;

FIG. 2 is a perspective view of the mechanism 30 in its first position from above with the cover 2 and assembly screws 3 removed;

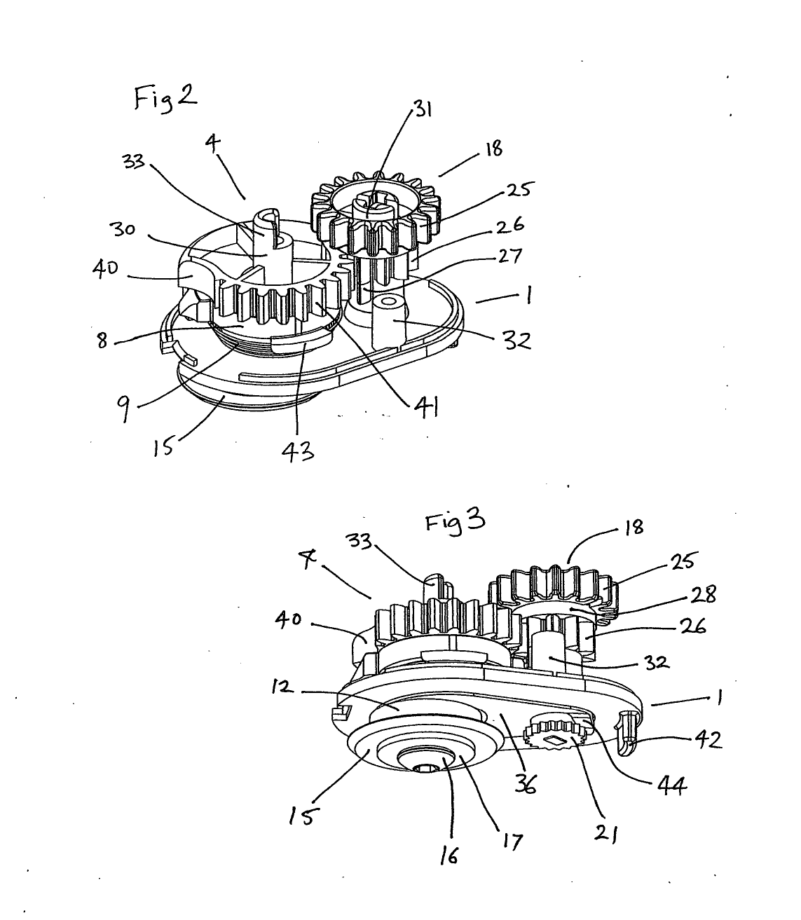

FIG. 3 is a perspective view of the mechanism 30 from below with the cover 2 and assembly screws 3 removed;

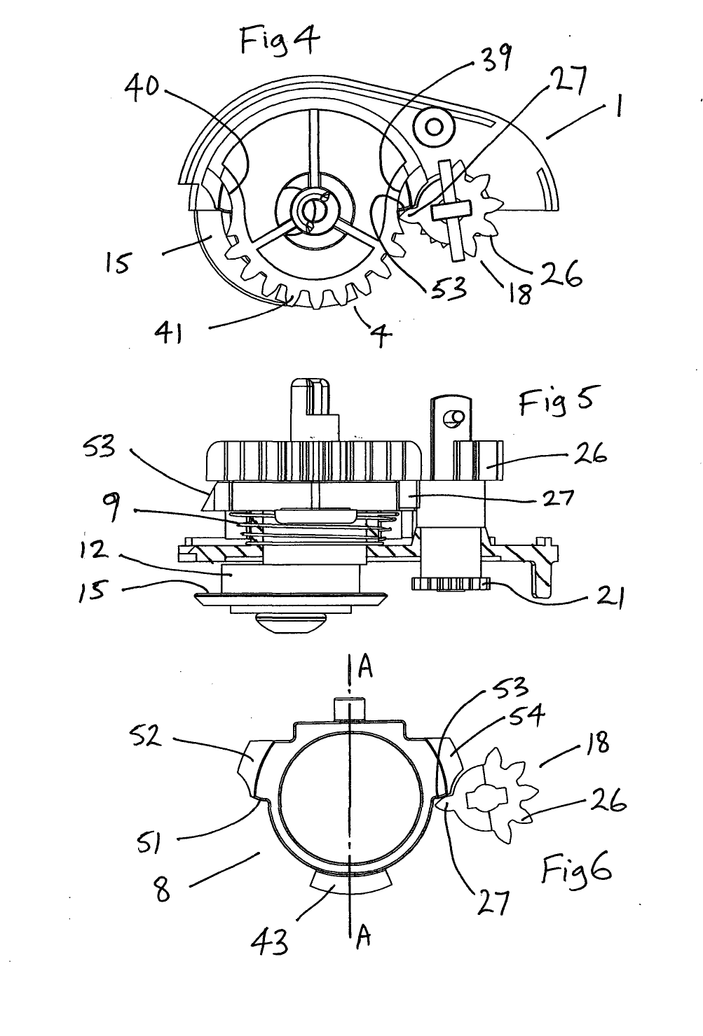

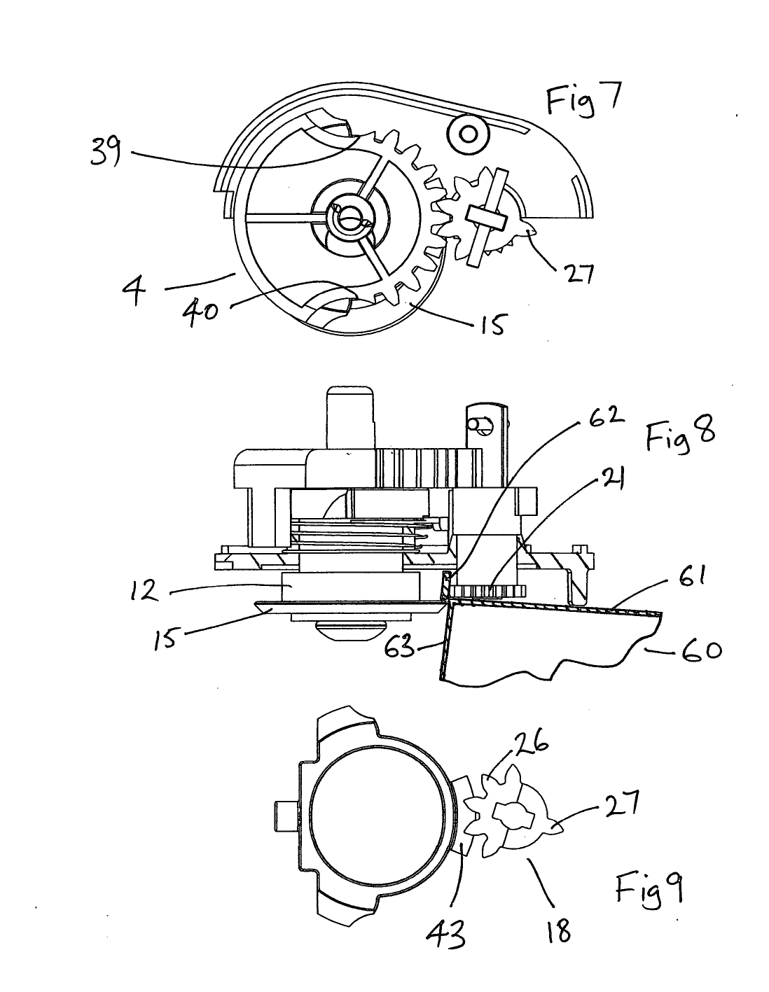

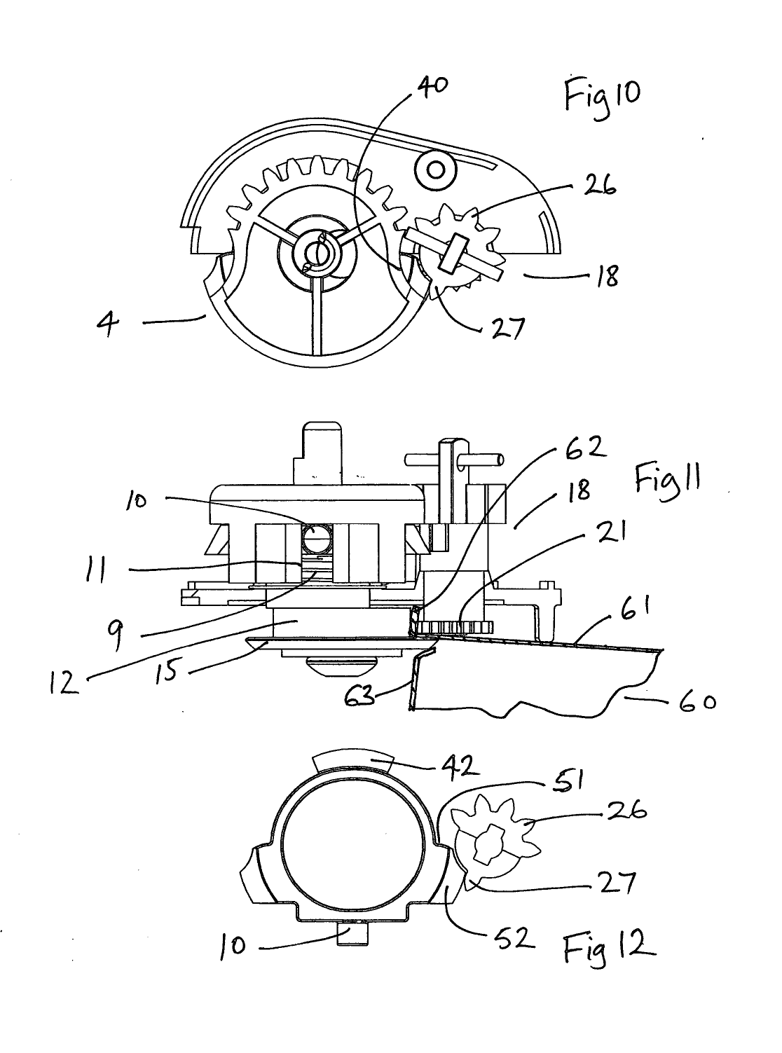

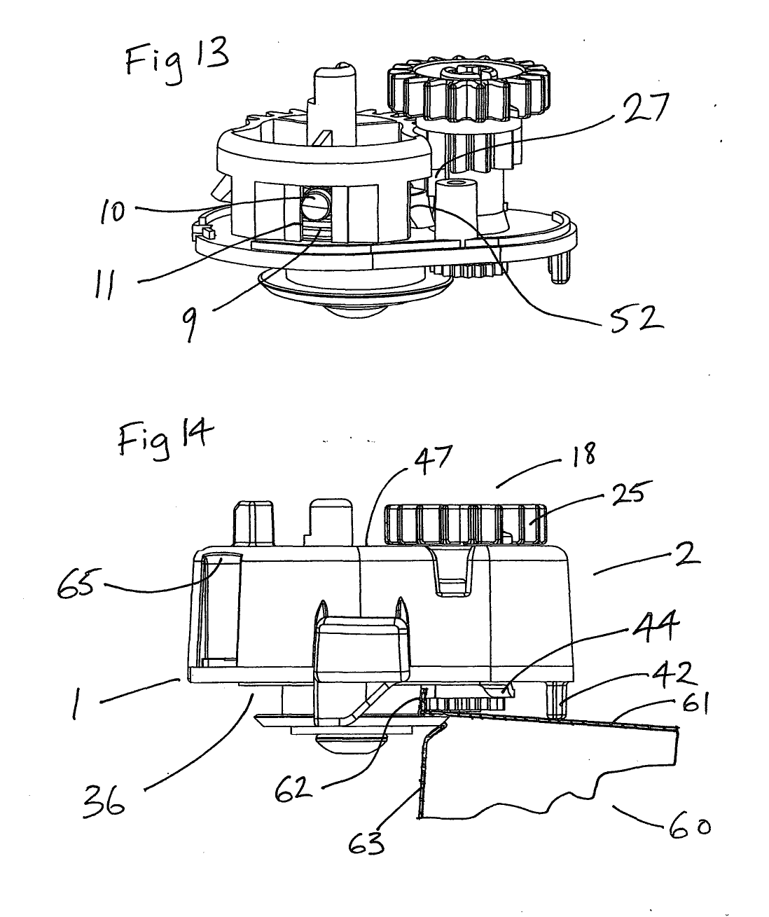

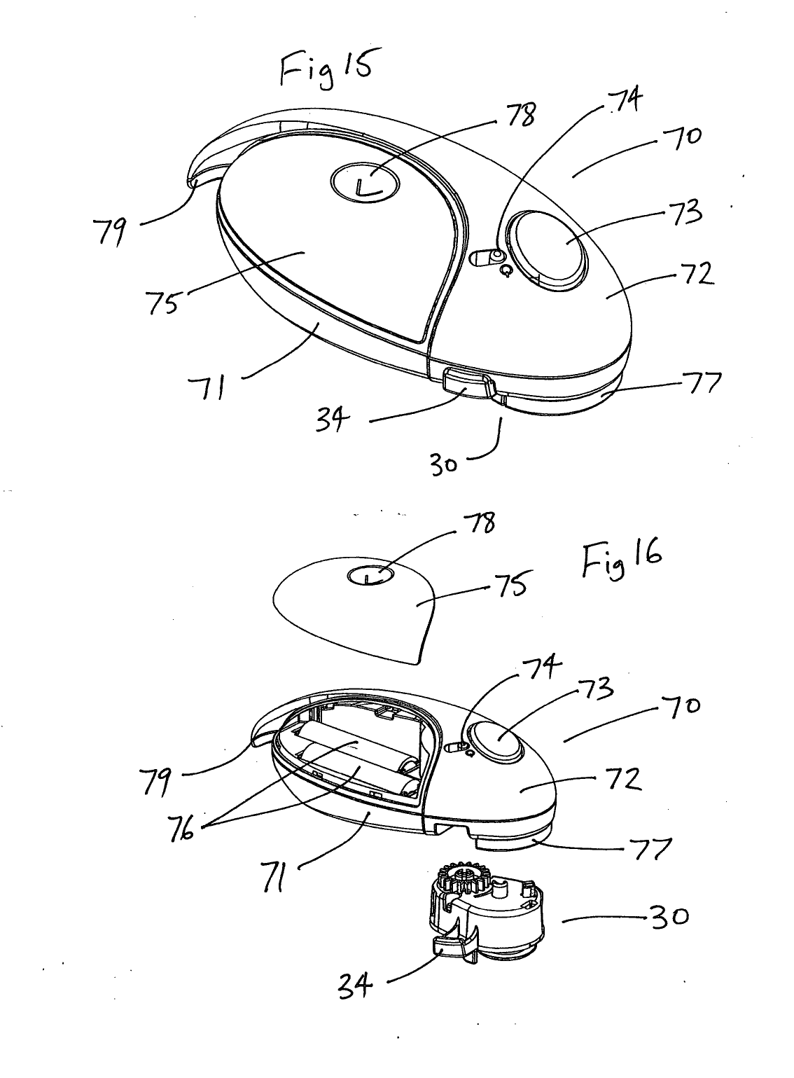

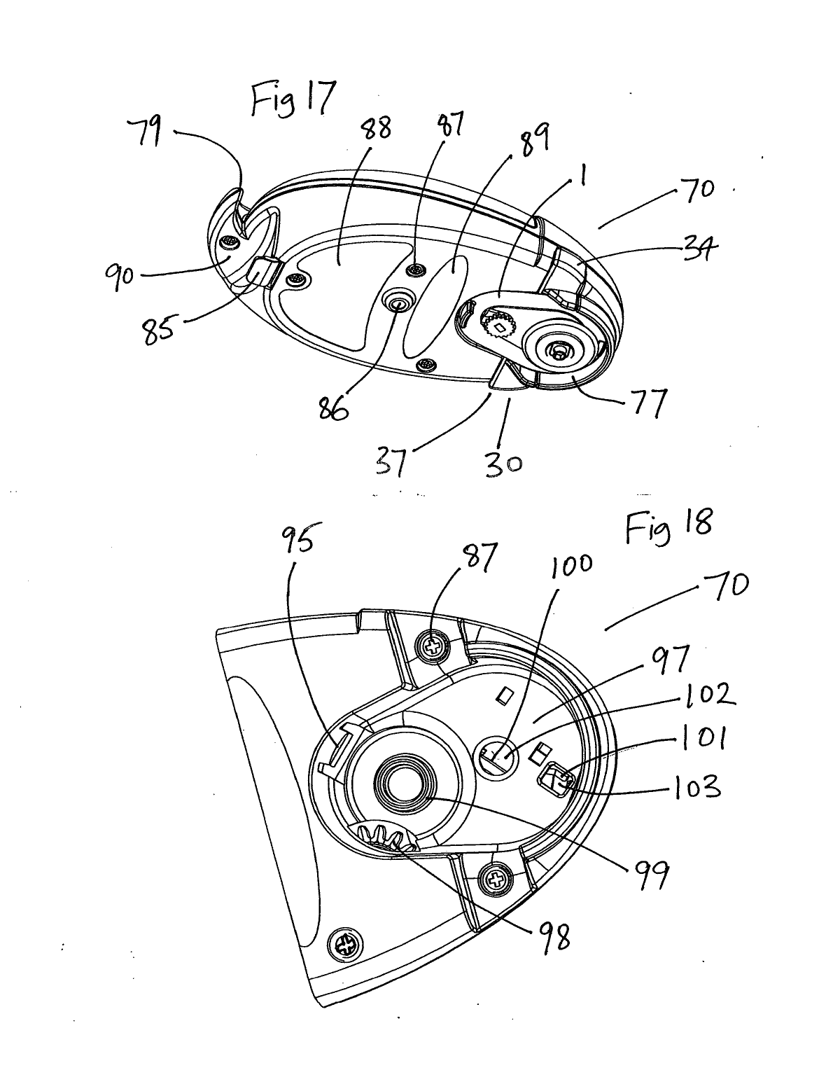

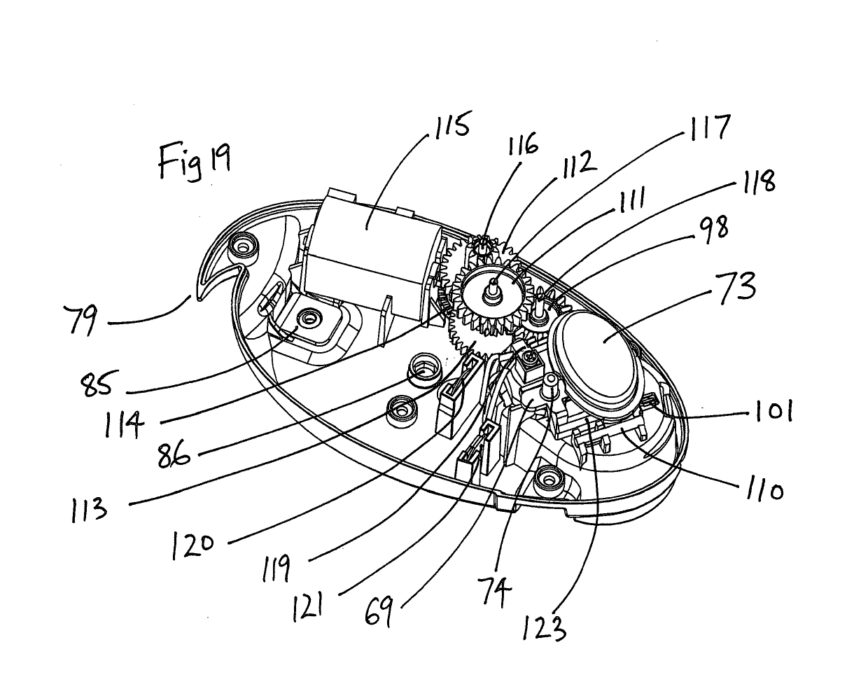

FIG. 4 is a plan view of the mechanism 30 with the cover 2, wear plate 36 and assembly screws 3 removed and the body 1 shown cut in half with the drive wheel 18 trimmed to remove the input gear 25 and the drive wheel upper bearing surface 28 for clarity.

FIG. 5 is a side elevation of the mechanism 30 of FIG. 4.

FIG. 6 is a plan view of the mechanism 30 of FIG. 4 showing only the ratchet module 8 and the drive wheel 18.

FIG. 7 is a plan view of the mechanism 30 of FIG. 4 with the cutter wheel 4 having been rotated through half its range of rotary movement.

FIG. 8 is a side elevation of the mechanism 30 of FIG. 7 and includes a scrap section of a can 60.

FIG. 9 is a plan view of the mechanism 30 of FIG. 7 showing only the ratchet module 8 and the drive wheel 18.

FIG. 10 is a plan view of the mechanism 30 of FIG. 4 with the cutter wheel 4 having been rotated through its full range of rotary movement to its second position.

FIG. 11 is a side elevation of the mechanism 30 of FIG. 10 and includes a scrap section of a can 60.

FIG. 12 is a plan view of the mechanism 30 of FIG. 10 showing only the ratchet module 8 and the drive wheel 18.

FIG. 13 is a perspective view of the mechanism 30, in its second position, from the side with the cover 2 and assembly screws 3 removed;

FIG. 14 shows a side view of the mechanism 30 with a scrap section of a can 60 shown for clarity.

FIG. 15 shows a perspective view of an electric can opener 70 that houses mechanism 30 and with the master switch knob 74 in its first position.

FIG. 16 shoes the electric can opener 70 of FIG. 15 with the mechanism 30 removed and the battery door 75 opened.

FIG. 17 shows a perspective view of the underside of an electric can opener 70 with the mechanism 30 in place.

FIG. 18 shows a detail view of the mechanism recess 97 on the underside of the electric can opener 70.

FIG. 19 shows the electric can opener 70 with the mechanism 30 and the upper housing 72 removed and with the master switch 69 in its first position.

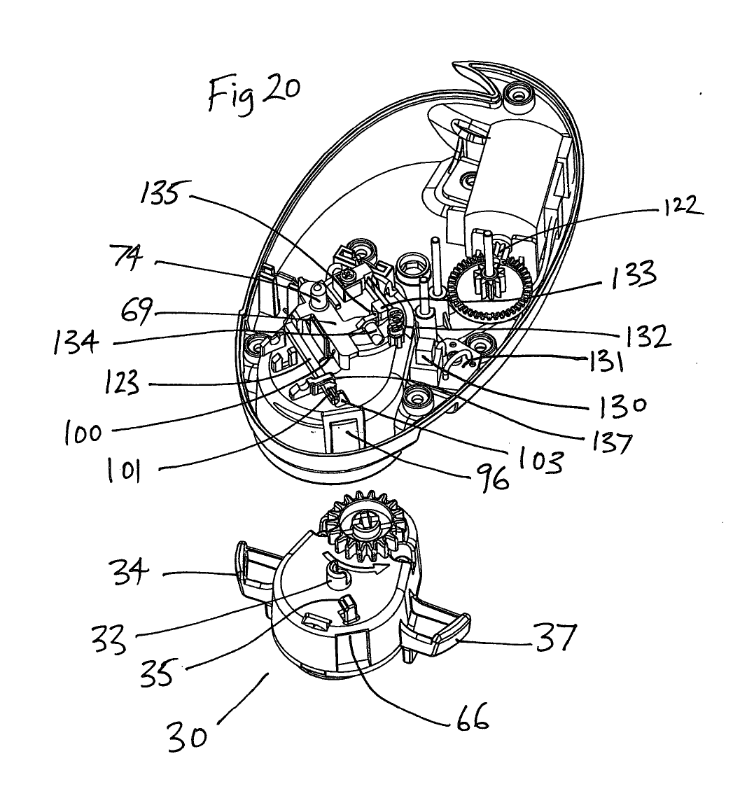

FIG. 20 shows the electric can opener 70 with the mechanism 30 removed but visible below it and the upper housing 72 and button 73 removed and with the master switch 69 in its first position.

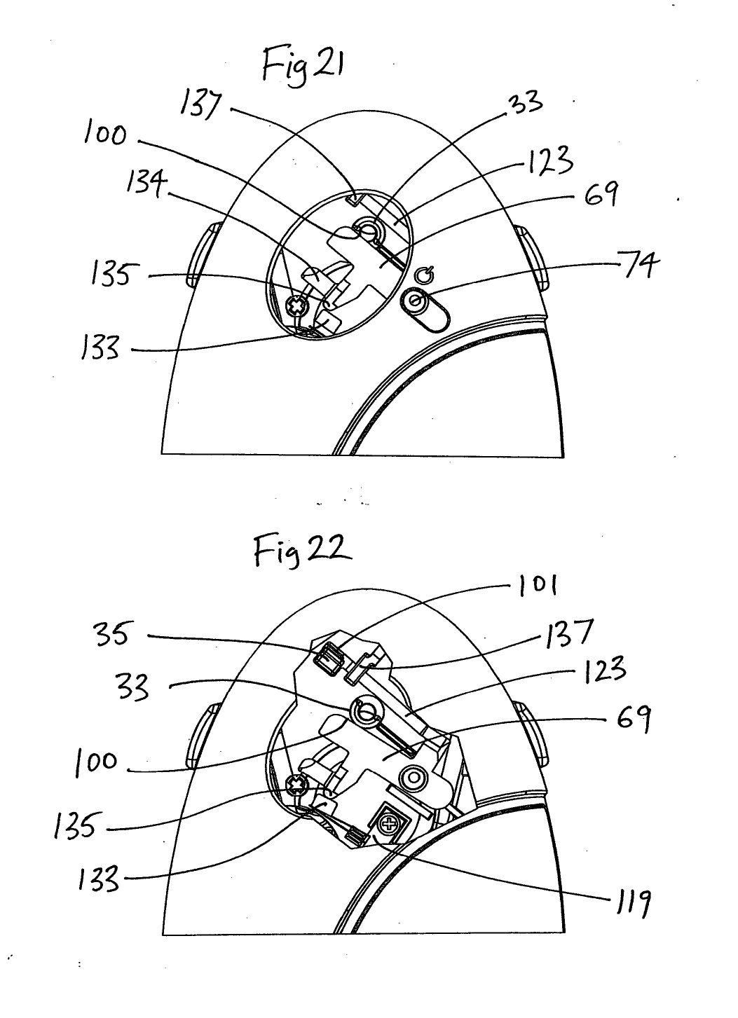

FIG. 21 shows a detail of the electric can opener with the button 73 removed and the master switch 69 in the first position with the cam 33 of mechanism 30 not pressing against cam follower 100.

FIG. 22 shows the electric can opener of FIG. 21 but with extra sections of the upper housing 72 removed for clarity and with the cam 33 of mechanism 30 fully pressing against cam follower 100.

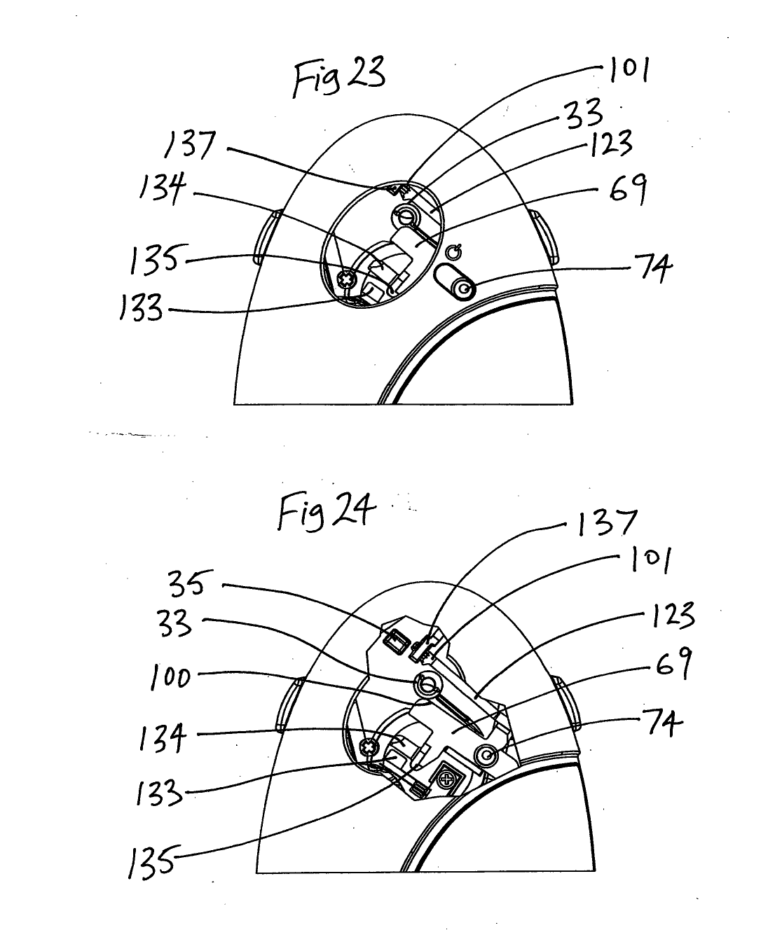

FIG. 23 shows the electric can opener of FIG. 21 but with the master switch 69 in the second position.

FIG. 24 shows the electric can opener of FIG. 23 but with extra sections of the upper housing 72 removed for clarity and with the cam 33 of mechanism 30 fully pressing against cam follower 100.

FIG. 25 shows the electric can opener 70 with the upper housing 72 and gears 111, 112, 113, 114, 98 removed and the button 73 cut away for clarity. The master switch 69 is in its first position.

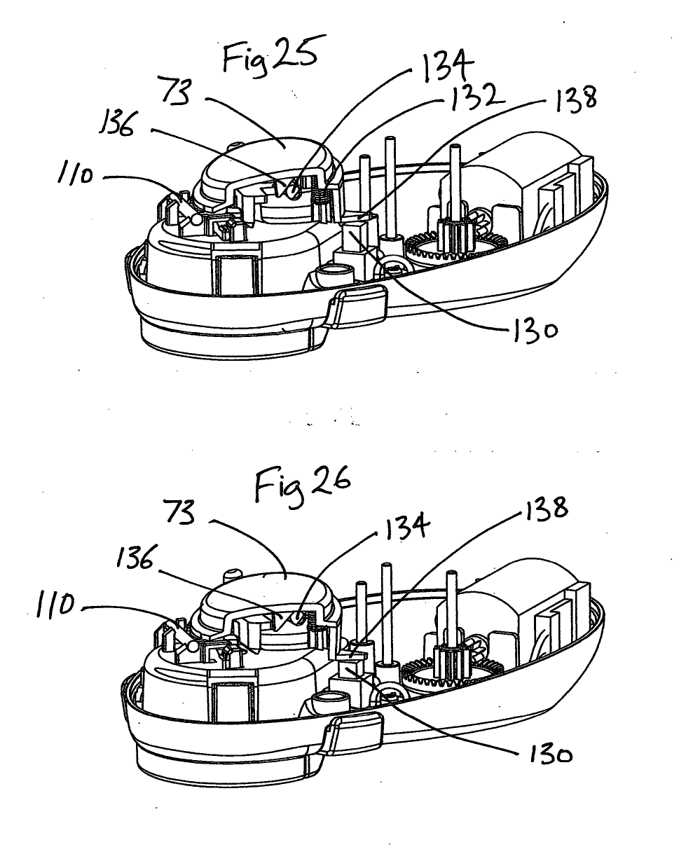

FIG. 26 shows the electric can opener 70 of FIG. 25 and with the button 73 depressed.

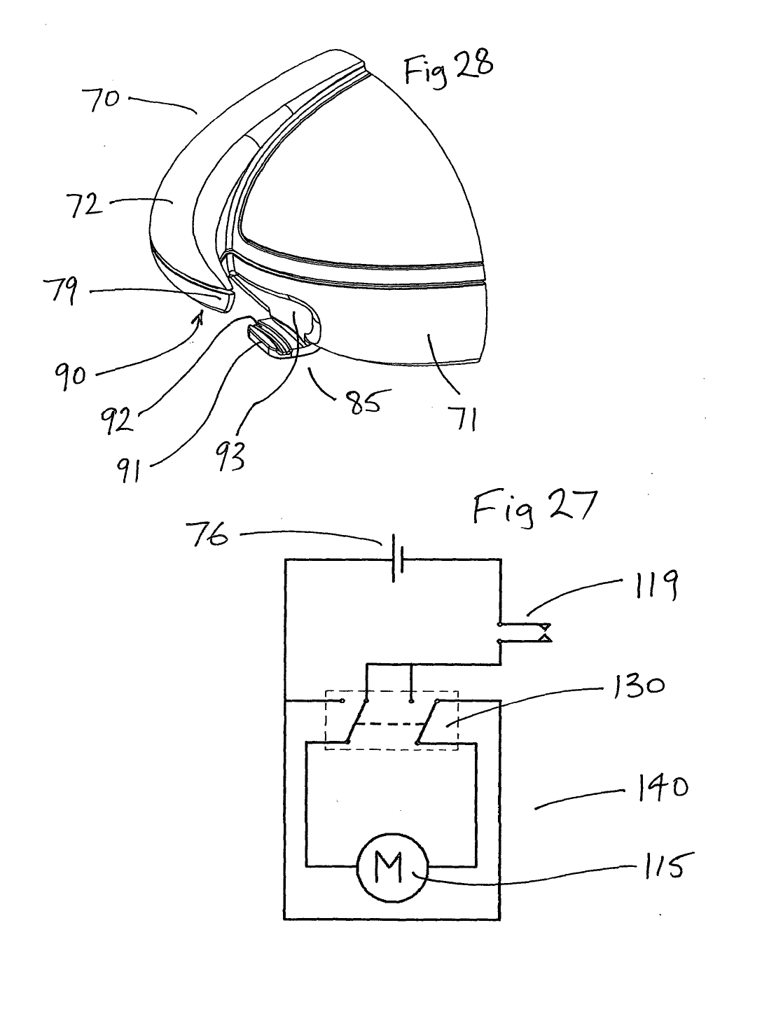

FIG. 27 shows a schematic circuit 140 of electric can opener 70. FIG. 28 shows a detail view of the hook 79 and metal plate 85.

Referring to FIG. 1 a body 1 and cover 2 are shown with assembly screws 3. A cutter wheel 4 with cutter wheel lower bearing surface 5 and cutter washer bearing surface 6 is able to pass through cutter wheel bearing support 7 and rotate freely within it. Cutter wheel upper bearing surface 30 can rotate freely in cutter wheel bearing surface 31 in cover 2. A ratchet module 8 and ratchet spring 9 are able to fit on the outside of cutter wheel bearing support 7 and rotate freely around it. Peg 10 is able to freely slide in slot 11 so that the ratchet module 8 always rotates with cutter wheel 4. Cutter washer 12 has a square boss 13 that locates into square recess 14 in cutter 15. A cutter screw 16 and washer 17 screw into cutter wheel 4 to secure the cutter 15 and cutter washer 12. Body 1 and wear plate 36 are sandwiched between the washer 17 and the cutter wheel 4. Drive wheel 18 has drive gear lower bearing surface 19 that can rotate freely within drive gear bearing support 20. Serrated drive teeth 21 is securely riveted to the end of drive shaft 22 which has a securing hole 23 for securing pin 24 which is used to secure the drive shaft 22 after it has been passed through drive gear 18, sandwiching wear plate 36, body 1 and cover 2 between the serrated drive teeth 21 and the input gear 25 of drive wheel 18. Interference gear tooth 27 is attached to drive wheel 18 just below drive gear 26. Drive wheel upper bearing surface 28 can rotate freely in drive wheel bearing surface 29 in cover 2. Also visible are screw bosses 32, cam 33, right removal wing 34 and lock plate 35.

FIG. 2 shows a top perspective view of the mechanism 30 with cover 2 and assembly screws 3 removed for clarity. A second toothless zone 40 can be seen adjacent to a section of radial gear teeth 41 on the cutter wheel 4. Ratchet spring support 43 is attached to ratchet module 8 to support ratchet spring 9. Drive wheel top bearing face 31 can also be seen.

FIG. 3 shows a perspective view from underneath the mechanism 30 with the cover 2 and assembly screws 3 removed for clarity and the mechanism 30 in the first position. The cutter 15 can be seen to be spaced apart from serrated drive teeth 21 with sufficient space for a can rim 62—shown in FIG. 8—to be inserted between them. A support ridge 44 can be seen supporting the serrated drive teeth 21 and a can rest 42 is shown attached to the body 1.

Referring to FIGS. 4, 5 and 6, the mechanism 30 is shown in the first position with the cutter 15 and cutter washer 12 at its furthest position from the serrated drive teeth 21. The drive gear 26 can be seen engaged with first toothless zone 39 which is adjacent to radial gear teeth 41 and second toothless zone 40 can be seen at the other end of the radial gear teeth 41. If the drive gear 26 was rotated clockwise it would turn without engaging any of the radial teeth 41 and the cutter wheel 4 would not rotate. However, referring to FIG. 6 for clarity, the interference gear tooth 27 would engage with first contact face 53 which is formed as if it was a gear in the section of radial gear teeth 41. As the first contact face 53 is part of ratchet module 8, the interference gear tooth 27 would start to turn the ratchet module 8 which would in turn rotate cutter wheel 4 via peg 10 and slot 11 shown in FIG. 1. As soon as the cutter wheel 4 had turned a few degrees, drive gear 26 would engage with the closest tooth in section of radial teeth 41 and continue to rotate the cutter wheel 4. As the cutter wheel 4 rotated, the cutter 15 and cutter washer 12 would move towards the serrated cutter teeth 21.

If the drive gear 26 was instead rotated anticlockwise, the interference gear tooth 27 would rotate almost an entire revolution before it started to engage first chamfer 54 on ratchet module 8. As a result the ratchet module 8 would be pushed downwards by the interference gear tooth 27 and compress ratchet spring 9. As soon as the interference gear tooth 27 rotated past first contact face 53, the ratchet spring 9 would push ratchet module 8 upwards back into its original position. The result would be that the drive gear 25 could be rotated continuously in the anticlockwise direction without moving the cutter wheel 4, the only movement being that of the ratchet module 8 moving up and down against ratchet spring 9. It may be noted that in this embodiment, ratchet module 8 is symmetrical about line A-A so that first contact face 53 and first chamfer 54 are mirror images of second contact face 51 and second chamfer 52.

Referring to FIGS. 7, 8 and 9, the mechanism 30 is shown midway between first and second positions and with the drive gear 26 engaged with the section of radial teeth 41 and the cutter wheel 4 having been rotated through half its range of movement. The cutter 15 is about to start to overlap the serrated drive teeth 21 and can be seen to be starting to pierce the can wall 63 of can 60 whilst the serrated drive teeth 21 is pressing against can rim 62 and resting above can lid 61. In FIG. 9 the interference gear tooth 27 can be seen pointing away from the ratchet module 8 and the teeth of the drive gear 26 can be seen above and not interacting with the spring support 42. As drive gear 26 continues to rotate the cutter 15 will pierce the can wall and the cutter washer 12 will clamp the can rim 62 against the serrated drive teeth 21.

Referring to FIGS. 10, 11 and 12, the mechanism 30 is shown in its second position with the cutter wheel having rotated to its full extent with the drive gear having reached the second toothless zone 40 and therefore not able to engage with the radial gear teeth 41. As the drive wheel 18 continues to turn clockwise the interference gear tooth 27 can be seen about to strike second chamfer 52. As this happens the action of the tooth on the chamfer will push the ratchet member 8 downwards against ratchet spring 9. As interference gear tooth 27 continues to rotate it will eventually rotate clear of second contact face 51 at which point the ratchet module 8 will spring back into position due to ratchet spring 9. In FIG. 11, peg 10 can clearly be seen within slot 11 and can rim 62 can be seen clamped between cutter washer 12 and serrated drive teeth 21 with cutter 15 having pierced can 60 and in the process of cutting can lid 61 away from can wall 63. As the drive wheel 18 continues to rotate clockwise the can lid 61 will be completely severed from the can wall 63.

Once the can lid 61 has been completely severed from can 60, the drive wheel 18 can be turned anticlockwise. The interference gear tooth 27 will rotate until it pushes against second contact face 51 and as a result it will start to rotate the ratchet module 8 which in turn rotates cutter wheel 4 due to peg 10 being trapped in slot 11. As soon as cutter wheel 4 has rotated a few degrees, gear teeth 26 will engage with the nearest tooth in the section of radial teeth 41 and start to directly drive the cutter wheel 4. As the cutter wheel 4 rotates it carries the cutter 15 and cutter washer 12 away from the serrated drive teeth 21 and the can 60 so that the can rim 62 is released and the severed can lid 61 may be removed. The cutter wheel 4 will continue to be rotated by drive gear 26 until the first toothless zone 39 loses drive engagement with drive gear 26. At this stage the cutter wheel will stop rotating. If the drive wheel 18 continues to rotate anticlockwise, the interference gear tooth will periodically strike the second chamfer 52 on the ratchet module 8 and push it downwards against ratchet spring 9. In this manner the drive wheel 18 can continue to rotate without driving the cutter wheel 4 and without jamming.

FIG. 13 shows the interference gear tooth 27 as it strikes second chamfer 52 and pushes ratchet module 8 downwards against ratchet spring 9. Peg 10 in slot 11 can be seen to have moved downwards slightly as ratchet module 8 tilts to allow interference gear tooth 27 to slide up second chamfer 52.

FIG. 14 shows input gear 25 of drive wheel 18 and also serrated drive teeth 21 with the cover 2, body 1 and wear plate 36 between them. The position of the serrated drive teeth 21 relative to the wear plate 36 is dictated by the support ridge 44 and the input gear 25 resting on the cover top surface 47. The can lid 61 can also be seen resting against can rest 42 and first retention lip 65 is visible in the cover 2.

There is therefore provided a mechanism 30 with a drive wheel 18 that when turned in a clockwise direction, moves a cutter 15 and cutter washer 12 mounted on a cutter wheel 4 from a first (parked) position to a second (cutting) position during which a can wall 63 is pierced and a can rim 62 is gripped and then fed between a serrated drive teeth 21 and a cutter washer 12 so that the penetrating cutter 15 completely severs the can lid 61 from the can wall 63. The drive wheel 18 can then be turned anticlockwise to rotate the cutter wheel 4 and move the cutter 15 and cutter washer 12 away from the serrated drive teeth 21 so that the can lid 61 and can rim 62 are released and the cutter 15 and cutter washer 12 are returned to the first (parked) position ready to be used again.

The drive wheel 18 may be rotated continuously in selected directions when in the first or second positions as the drive gear 26 disengages from the section of radial teeth 41 in either the first toothless zone 39 or the second toothless zone 49 and the ratchet module 8 allows interference gear tooth 27 to pass by it without turning cutter wheel 4. But if the direction of rotation is reversed the interference gear tooth 27 rotates the cutter wheel 4 via ratchet module 8 and allows the drive wheel 18 to reconnect to the cutter wheel 4 by reengaging the drive gear 26 and the section of radial teeth 41.

The clockwise and anticlockwise rotation directions may be reversed by rotating the cutter wheel 4 half a turn about its axis of rotation within body 1 or by rotating the position of cutter washer bearing surface 6 by half a turn about the axis of rotation of the cutter wheel 4 within body 1.

FIG. 15 shows an electric can opener 70 that can house mechanism 30. The main component parts are a lower housing 71, upper housing 72, button 73, master switch knob 74 and battery door 75. A depression 78 helps the user to open the battery door 75. Right removal wing 34 can be seen as well as a cutter wall 77.

FIG. 16 shows the battery door 75 open to reveal battery 76 and mechanism 30 is shown removed from electric can opener 70 as it would be for washing.

FIG. 17 shows the underside of the electric can opener 70 with a first and second label 88, 89, a magnet 86 for retention of a severed can lid 61 and a metal plate 85 positioned below opening face 90. Left removal wing 37 is also visible.

In FIG. 18 the underside of the electric can opener 70 is shown with mechanism 30 removed and with the mechanism recess 97 being the main feature. Within the recess can be seen first retention clip 95 that clips against first retention lip 65 to hold mechanism 30 in position when it is inserted into mechanism recess 97. Also visible is mechanism bearing 99 that houses and supports the drive wheel 18 via drive wheel top bearing face 31 when the mechanism 30 is inserted. Cam follower 100 can be seen through cam hole 102 which allows cam 33 to pass through it. Lock tab 101 can be seen through lock hole 103 that allows lock plate 35 to pass through it.

In FIG. 19 the electromechanical drive of the electric can opener 70 are exposed. A motor 115 transmits rotary power via a motor pinion gear 122 (not visible), a first, second, third and fourth gear 114, 113, 112, 111 and to the drive input 25 (not visible) via transfer gear 98. First, second and third axles 116, 117, 118 provide location for these gears. Master switch 69 is visible below button 73 which pivots on button pivot 110. Electrical components such as leaf switch 119 and first and second battery contacts 120, 121 are also visible. The internal section of metal plate 85 is visible close to hook 79. Lock tab 35 can be seen and is connected to master switch knob 74 via sprung section 123.

In FIG. 20 the button 73 is removed to show more details of master switch 69. It has a sprung section 123 terminating in a lock tab 101 that can slide beneath lock plate 35 when the mechanism 30 is installed, a cam follower 100 that follows cam 33 when the mechanism 30 is installed, a master switch cam 135 that can press against leaf switch follower 133, and a button follower 134 that can press against a button cam 136 (not shown). The master switch knob 74 is able to slide the master switch 69 between a first position (shown) and a second position. In this view a reverse switch 130 and circuit board 131 can be seen as well as button spring 132 that returns the button 73 to its original position when it is not being depressed. Locator block 137 can be seen and simply locates sprung section 123.

In FIG. 21 the master switch 69 is in the first position and the lock tab 101 is engage with the lock plate 35 (see FIG. 22). The mechanism 30 is in its first position so cam 33 is not pressing against cam follower 100 so the master switch has not been affected and as a result master switch cam 135 is not pressing against leaf switch follower 133 so leaf switch 119 is not in a closed condition. Locator block 137 is visible and simply locates sprung section 123 and lock tab 101.

In FIG. 22 the mechanism 30 has moved from the first position and as a result cam 33 has pressed against cam follower 100 and moved the master switch 69. Master switch cam 135 has now pressed against leaf switch follower 133 and leaf switch 119 is now in a closed condition as a result. Lock tab 101 can be seen below lock plate 35 and as a result the mechanism 30 is now locked in recess 97.

FIG. 23 is similar to FIG. 21 but with the master switch 69 now in its second position and the mechanism 30 in its first position. The cam 33 is not pressing against cam follower 100 and as a result the master switch cam 135 is not pressing against leaf switch follower 133 so leaf switch 119 is not in a closed condition. Lock tab 101 has been retracted from lock plate 35 (see FIG. 24).

In FIG. 24 the mechanism 30 has moved from the first position and as a result cam 33 has pressed against cam follower 100 and moved the master switch 69. However in this case the master switch cam 135 has not made contact with leaf switch follower 133 so leaf switch 119 is not in a closed condition. Lock tab 101 has moved away from lock plate 35 and as a result the mechanism 30 is no longer locked in recess 97. Locator block 137 is visible and simply locates sprung section 123 and lock tab 101.

In FIG. 25 the button cam 136 can be seen adjacent to button follower 134 but not in contact with it. Reverse switch plate can also be seen just above reverse switch 130.

In FIG. 26 the button 73 has been depressed and pivoted about button pivot 110. As a result the reverse plate switch 138 has depressed reverse switch 130 and button cam 136 has pressed and moved button follower 134. The master switch 69 has therefore taken the position shown in FIG. 22, regardless of the position of cam 33.

If however the master switch 69 is in its second position as shown in FIG. 23, when the button 73 is depressed the button cam 136 will not strike the button follower 134 but will instead pass beside it. As a result the button 73 has no effect on the master switch 69 when it is in its second position.

FIG. 27 shows the circuit 140 of the electric can opener 70 with the battery 76, leaf switch 119, reverse switch 130 and motor 115. Whenever the leaf switch 119 is in the closed condition, either as a result of the cam 33 or the button cam 136 moving the master switch 69, power will flow from the battery 76 to the motor 115. This will cause the input gear 25 to be turned by the motor 115 via gears 111, 112, 113, 114, 98, 122 and its direction will be controlled by the position of reverse switch 130 which is of a latching type so each time it is pressed the polarity to the motor is reversed.

The described arrangement of button 73, cam 33, master switch 69 and circuit 140 provides a system in which the electric can opener 70 with cutter wheel in its first position can be electrically switched on by momentarily pressing the button 73 for long enough that cam 33 rotates sufficiently to keep the leaf switch 119 closed when button 73 is released. The reverse button 130 will also have been switched to a condition in which the motor direction results in the clockwise rotation of drive wheel 18. The electric motor 115 will therefore continue running, move the drive wheel to its second position and continue until such time that button 73 is momentarily pressed again. This will only have the effect of reversing the polarity to the motor 115 so the drive wheel 18 begins to rotate in an anticlockwise direction and drives the cutter wheel 4 to its first position. The power to motor 115 will be cut because cam 33 will allow master switch 69 to return to move away from leaf switch 119 and therefore the circuit will be broken.

At any time when the motor is running the master switch 69 can be moved from its first position to its second position and thereby stop master switch cam 135 pressing leaf switch follower 133 resulting in the leaf switch 119 moving to an open condition and cutting power to the motor 115.

As a result the master switch 69 can be used to:
Isolate power so the motor 115 cannot be energised;
Break the circuit when the motor is running;
Lock the mechanism 30 into its recess 97
Release the mechanism 30 so it can be unclipped from its recess 97 by pulling on left and right removal wings 34, 37.

In FIG. 28 the metal plate 85 is shown in more detail with a sharp edge 91 and a groove 92. The metal plate 85 is angled upwards relative to the opening face 90 and performs three separate opening functions:
if a beer bottle style crown cap is placed between the opening face 90 and the sharp edge 91 or groove 92, it can be levered off by tilting the electric can opener 70;
if a vacuum sealed jar lid is placed between the opening face 90 and the sharp edge 91, the lid edge can be levered away from the glass jar by tilting the electric can opener 70 and the vacuum released;
the metal plate 85 can be used to lever open a cocoa style tin, a function often carried out by a teaspoon handle or similar flat piece of metal.

The hook 79 is also able to perform three separate opening functions:
The hook 79 can be used to open food cans that have ring pull type tabs;
The hook 79 can be used to open ring pull style soda can tabs;
The hook 79 can be used to open captive soda can tabs.

In a second embodiment, the mechanism 30 can be used in a manual form in which an elongated section is added to it or formed from either the body 1, the cover 2, or both, to provide a handle. A rotary input can then be applied to the drive wheel in the form of a butterfly handle or a rotary lever and the resulting manual can opener can will pierce and sever a lid whilst the rotary input is turned clockwise, or release the lid when it is turned anticlockwise.

While the preferred embodiments of the invention have been shown and described, it will be understood by those skilled in the art that changes or modifications may be made to them without departing from the true spirit and scope of the invention.

We claim:

1. A mechanism for use in an opener for a can, said can comprising a cylindrical or rectangular wall that is closed at either end with a lid sealed to the can by means of an upstanding rim that clamps onto each end of the can wall, said mechanism comprising;
A body;
rotationally mounted to said body about a first axis, a drive wheel with serrated drive teeth for engaging the rim of the can, a full set of concentric drive gear teeth and at least one interference gear tooth in a parallel plane to the drive gear teeth;
rotationally mounted to said body about a parallel second axis a cutter wheel with a section of radial gear teeth set between a first toothless zone and a second toothless zone such that the radial gear teeth are drivably rotatable by said drive wheel's drive gear teeth when they are engaged;
eccentrically mounted to said cutter wheel, a cutter movable on rotation of the cutter wheel to a cutting position in which the cutter overlaps the serrated drive teeth such that a can wall placed between the serrated drive teeth and the cutter would be pierced by the cutter whilst the can rim would be gripped between the serrated drive teeth and a cylindrical cutter spacer mounted adjacent to the cutter and concentric with it such that the can wall would be continuously cut as the can rim was driven by the serrated drive teeth;
mounted to the cutter wheel in the same plane as the at least one interference tooth, a ratchet member that is able to either engage with said at least one interference gear tooth so that the drive wheel can drivably rotate the cutter wheel at times when said section of radial gear teeth is not engaged with said drive gear teeth, said ratchet member being able to alternatively move out of engagement with said at least one interference gear tooth if the drive wheel is being rotated in the opposite direction with there being no resulting rotary drive.

2. The mechanism of claim 1 in which the at least one interference gear tooth has the same pitch diameter as the drive gear teeth.

3. The mechanism of claim 1 in which the ratchet member has a first and a second protrusion that can come into contact with the at least one interference gear tooth.

4. The mechanism of claim 3 in which the first and a second protrusions each have two profiles, the first of which is a tooth profile with the same pitch diameter as the radial gear teeth of the cutter wheel and which can engage with the at least one interference tooth resulting in rotary drive between the drive wheel and the cutter wheel and the second profile being a ramp profile that pushes the protrusion out of engagement with the at least one interference tooth resulting in no resulting rotary drive.

5. The mechanism of claim 3 in which when the first or second protrusions are pushed out of engagement with the at least one interference tooth they move out of the plane of the at least one interference tooth.

6. The mechanism of claim 5 in which a spring between the ratchet member and the body urges the ratchet member back into its start position after the at least one interference tooth has rotated beyond being in engagement with the ramp profiles of the first or second protrusions.

7. The mechanism of claim 5 in which a spring between the ratchet member and the cutter wheel urges the ratchet member back into its start position after the at least one interference tooth has rotated beyond being in engagement with the ramp profiles of the first or second protrusions.

8. The mechanism of claim 4 in which the first protrusion of the ratchet member is adjacent to the first toothless zone so that as the at least one interference tooth rotates within the first toothless zone in a first direction it will contact the ramp profile of the first protrusion so that the ratchet member is pushed out of the way of the at least one interference tooth with no resulting rotary drive and if the at least one interference tooth rotates within the first toothless zone in a second direction it will contact the tooth profile of the first protrusion so that the ratchet member and cutter wheel are rotationally driven about the second axis and the drive gear teeth will engage with the section of radial gear teeth on the cutter wheel.

9. The mechanism of claim 4 in which the second protrusion of the ratchet member is adjacent to the second toothless zone so that as the at least one interference tooth rotates within the second toothless zone in a second direction it will contact the ramp profile of the second protrusion so that the ratchet member is pushed out of the way of the at least one interference tooth with no resulting rotary drive and if the at least one interference tooth rotates within the second toothless zone in a first direction it will contact the tooth profile of the second protrusion so that the ratchet member and cutter wheel are rotationally driven about the second axis and the drive gear teeth will engage with the section of radial gear teeth on the cutter wheel.

10. The mechanism of claim 1 in which the ratchet member has at least one guide peg that is constrained by projections from the cutter wheel so that as the ratchet member is pushed out of position by the at least one interference tooth the at least one guide peg of the ratchet member slides between the projections.

11. The mechanism of claim 1 in which a cover is provided to enclose the mechanism and a first hole provided in the cover to allow rotational drive to be imparted to the drive wheel.

12. The mechanism of claim 1 in which the drive wheel is rotationally driven by an electric motor via a gear train.

13. The mechanism of claim 1 in which the drive wheel is rotationally driven by a manual rotary lever.

14. The mechanism of claim 11 in which the body and cover are extended to form a handle.

15. The mechanism of claim 1 in which a cam is mounted to the cutter wheel so that a cam follower can activate an electric switch.

16. The mechanism of claim 15 in which the cam protrudes through a second hole in the cover.

17. The mechanism of claim 11 in which a module consisting of the body, cover and enclosed mechanism are removably mounted in a further housing so that the module can be removed from the housing.

18. The mechanism of claim 3 in which the first and second protrusions are in the same plane as the at least one interference tooth.
